(19) United States
(12) Patent Application Publication
(10) Pub. No.: US 2011/0121724 A1
(43) Pub. Date: May 26, 2011

(54) FILAMENT FOR FLUORESCENT LAMP

(75) Inventor: Byung-Hyun Kim, Suwon-si (KR)

(73) Assignee: KUMHO ELECTRIC, INC., Seoul (KR)

(21) Appl. No.: 12/988,868

(22) PCT Filed: Apr. 23, 2008
(86) PCT No.: PCT/KR08/02289

§ 371 Date: Jan. 4, 2011

(51) Int. Cl. H01J 61/04

(52) U.S. Cl. 313/631

(57) ABSTRACT

The present invention relates to a filament for a fluorescent lamp, having a structure that can increase an amount of emitter applied thereto, and having optimized cold resistance (Rc) and a heat resistance (Rh) which capable of recognizing appropriate temperature thereof by which evaporation or scattering of the emitter can be decreased and maintaining a temperature thereof within an appropriate range, thereby reducing a loss rate of the emitter applied to the filament to increase the lifespan of the fluorescent lamp. The filament includes an inner coil wound in a spiral shape in one direction, a core wire wound in a spiral shape to surround the inner coil in a longitudinal direction of the inner coil, and an outer coil wound in a spiral shape to surround the core wire and surrounding the inner coil together with the core wire and characterized in that a ratio (Rh/Rc) between a heat resistance Rh and a cold resistance Rc of the filament is 4.8 to 6.2.

### TECHNICAL FIELD

The present invention relates to a filament for a fluorescent lamp, and more particularly, to a filament for a fluorescent lamp, having a structure that can increase an amount of emitter applied thereto, and having optimized cold resistance (Rc) and a heat resistance (Rh) which capable of recognizing appropriate temperature thereof by which evaporation or scattering of the emitter can be decreased and maintaining a temperature thereof within an appropriate range, thereby reducing a loss rate of the emitter applied to the filament to increase the lifespan of the fluorescent lamp.

### BACKGROUND ART

Fluorescent lamps are light sources in which ultraviolet light generated by discharge excites a fluorescent substance to generate visible rays, and have widely been used not only for general lighting but also as light sources for backlight units of liquid crystal displays (LCDs) in recent times.

In general, a fluorescent lamp includes a glass tube having an inner wall to which a fluorescent substance is applied, and a filament positioned at both ends of the glass tube. An emitter such as barium oxide (BaO), calcium oxide (CaO), strontium oxide (SrO), etc. is applied to the filament

FIG. 1 is a SEM image of a conventional filament. As shown in FIG. 1, a conventional filament 1 includes a core wire 2 wound in a spiral shape in one direction, and a coil 3 wound in a spiral shape to surround the core wire 2. FIG. 2 is a SEM image illustrating an emitter 4 is applied to the filament shown of FIG. 1.

When a voltage is applied to the filament 1 to increase the temperature of the filament 1 in a state where the emitter 4 is applied to the filament as shown in FIG. 2, the emitter 4 is exhausted to discharge electrons, the discharged electrons are collided with mercury injected into the glass tube to generate ultraviolet light, and the generated ultraviolet light excites a fluorescent substance applied to the inner wall of the glass tube to generate a visible ray. Accordingly, when the emitter 4 applied to the filament 1 is completely exhausted, electrons cannot be discharged so that the fluorescent lamp can not emit the light any more. As a result, the amount of the remained emitter 4 applied to the filament affects directly the lifespan of the fluorescent lamp.

However, as shown in FIG. 2, in the conventional filament 1, since the emitter 4 cannot be applied to a space S2 between a core region S1 and a coil, there is a limit in increasing the lifespan of the fluorescent lamp.

Further, if a temperature of the filament 1 is increased over an appropriate range, the emitter 4 is evaporated. On the contrary, if the temperature of the filament 1 is decreased below an appropriate range, a hot spot is generated on a portion of the filament 1 as shown in FIG. 3 and sputtering is generated on the hot spot to generate a scattering phenomenon in which the emitter 4 is scattered and blown away, and so the amount of the remained emitter is rapidly reduced, thus decreasing the lifespan of the fluorescent lamp.

In recent, furthermore, in order to improve a power saving, save a resource consumption, protect an environment and improve an efficiency of lighting devices, a fluorescent lamp including an ultra-fine tube having a diameter of 16 mm has been developed. In this case, a load exerted to a wall of the tube is increased, leading to an increased probability of early deterioration and early blackening of the fluorescent substance, and the width of an electrode is reduced, leading to a decrease in the emitter material to be applied. Thus, the lifespan of the fluorescent lamp is decreased.

### DISCLOSURE

### Technical Problem

The present invention is conceived to solve the foregoing and/or other problems, it is an aspect of the present invention to provide a filament for a fluorescent lamp, and more particularly, to a filament for a fluorescent lamp, having a structure that can increase an amount of emitter applied thereto, and having optimized cold resistance (Rc) and a heat resistance (Rh) which capable of recognizing appropriate temperature thereof by which evaporation or scattering of the emitter can be decreased and maintaining a temperature thereof within an appropriate range, thereby reducing a loss rate of the emitter applied to the filament to increase the lifespan of the fluorescent lamp.

### Technical Solution

The foregoing and/or other aspects of the present invention may be achieved by providing a filament for a fluorescent lamp including an inner coil wound in a spiral shape in one direction, a core wire wound in a spiral shape to surround the inner coil in a longitudinal direction of the inner coil, and an outer coil wound in a spiral shape to surround the core wire and surrounding the inner coil together with the core wire and characterized in that a ratio (Rh/Rc) between a heat resistance Rh and a cold resistance Rc of the filament is 4.8 to 6.2.

It is preferable that the cold resistance Rc of the filament may be 0.78 to 1.20Ω, and the heat resistance Rh may be 3.80 to 5.00Ω.

In particular, it is preferable that the outer coil is wound to form a space between the unit outer coil surrounding the inner coil and the adjacent unit outer coil surrounding the inner coil, and the inner coil, the outer coil and the core wire are electrically connected to each other.

In addition, it is preferable that a fluorescent lamp comprises the above filament and has a diameter of 16±0.2 mm.

### Advantageous Effects

According to a filament for a fluorescent lamp in accordance with an exemplary embodiment of the present invention, an emitter can also be applied to a space between a core region and a coil of the filament, to which the emitter could not be applied in the conventional filament so that an application amount of the emitter is increased three times or more, and an outer coil and an inner coil of the filament are configured to form a lattice structure and electrically connected with each other such that, even when the coil is cut, the fluorescent lamp can be lit. Thereby, the lifespan of the fluorescent lamp can be increased.

Further, a cold resistance Rc and a heat resistance Rh of the filament can be optimized to maintain the temperature of the filament at 795 to 1043° C., and thus, scattering and evaporation of the emitter generated from the filament can be suppressed to increase the remaining amount of the emitter. Thereby the lifespan of the fluorescent lamp can be increased.

### DESCRIPTION OF DRAWINGS

The above and other objects, features and advantages of the present invention will become apparent from the following description of preferred embodiments given in conjunction with the accompanying drawings, in which:

FIG. 1 is a SEM image of a conventional filament;

FIG. 2 is a SEM image of a conventional filament to which an emitter is applied;

FIG. 3 is an image of a conventional filament on which a hot spot is generated;

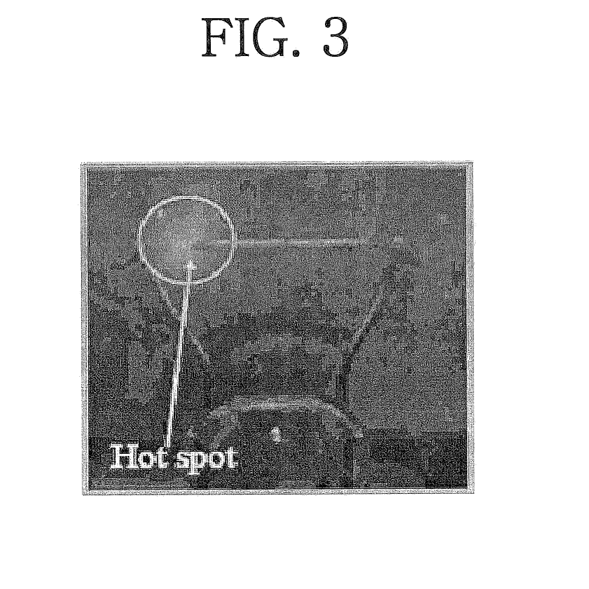

FIG. 4 is a SEM image of a filament according to the present invention;

FIG. 5 is a SEM image of the filament according to the present invention, to which an emitter is applied;

FIG. 6 is a view showing a structure of a portion of the filament according to the present invention;

FIG. 7 is a view showing a portion of the filament according to the present invention, which is cut; and

FIG. 8 is a graph showing a consumption amount of the emitter according to the temperature of the filament.

### MODES OF THE INVENTION

Hereinafter, a media separating device of an automatic media dispenser according to a preferred embodiment of the present invention will be described in detail with reference to the accompanying drawings.

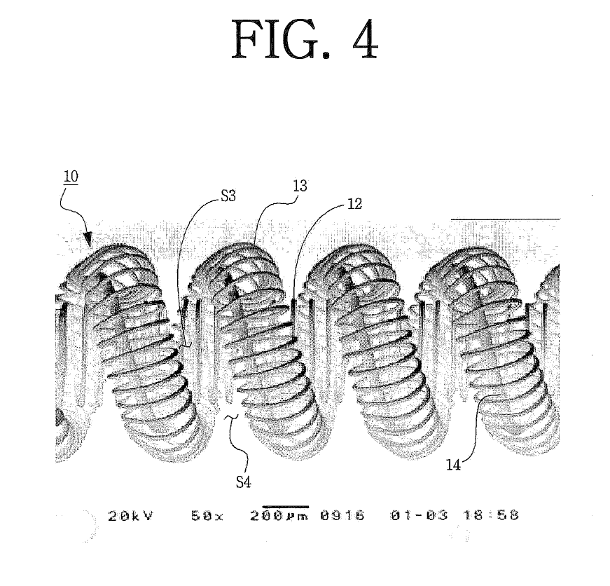

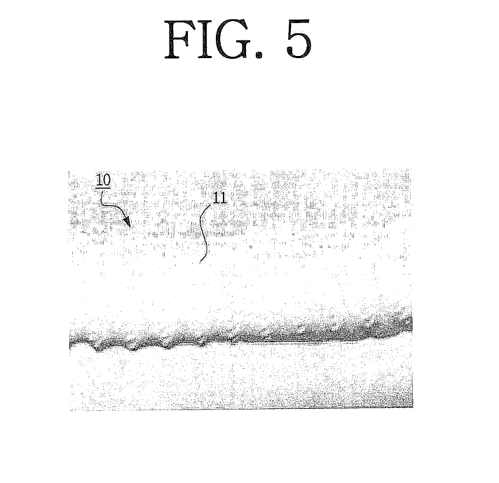

FIG. 4 is a SEM image of a filament 10 according to the present invention. FIG. 5 is a SEM image of the filament 10 shown in FIG. 4, to which an emitter such as barium oxide (BaO), calcium oxide (CaO) or strontium oxide (SrO), etc., is applied. Hereinafter, the above filament will be referred to as a triple filament.

As shown in FIG. 4, the filament 10 according to the present invention comprises an inner coil 12, an outer coil 13 and a core wire 14 passed through the outer coil 13. In particular, the inner coil 12 is wound in a spiral shape in one direction, the core wire 14 is wound in a spiral shape and surrounds the inner coil 12 in a longitudinal direction of the inner coil 12. And, the outer coil 13 is wound in a spiral shape and surrounds the core wire 14 surrounding the inner coil 12.

Unlike a conventional filament in which a space between a core region and the outer coil can not be filled by the emitter, therefore, a space between a core region S3 and the outer coil of the filament can be filled with the emitter 11, and so a larger amount of the emitter 11 may be applied. According to the inventor's experiments, while the total weight of the emitter that can be applied to the conventional filament was 3.5 mg, 11.5 mg of emitter was applied to the filament according to the present invention. That is, the total amount of the emitter applied was increased three times or more.

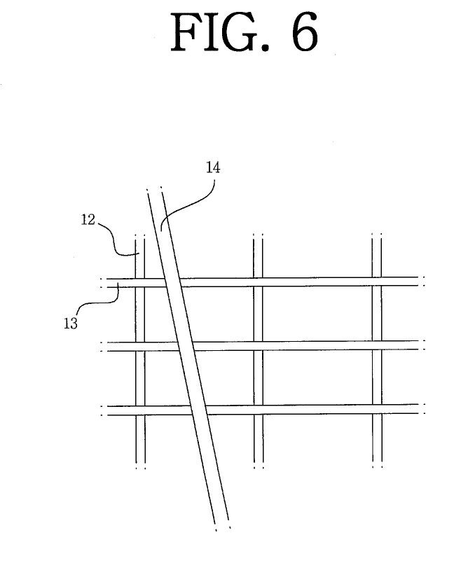

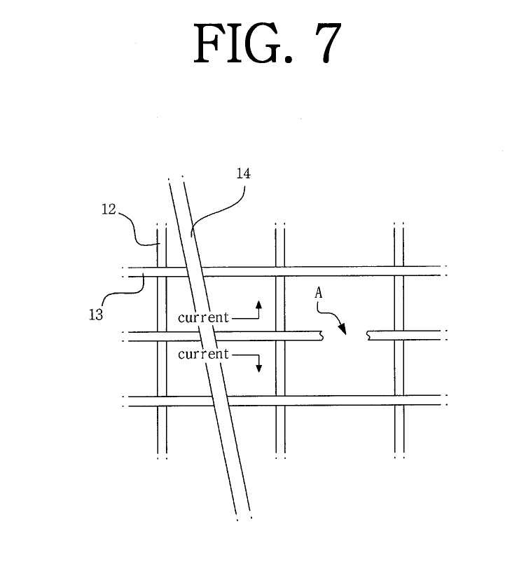

In addition, the filament 10 according to the present invention is wound such that a space S4 is formed between the ring shaped unit outer coil surrounding the inner coil and the adjacent ring shaped unit outer coil surrounding the inner coil to provide an appropriate resistance, and the outer coil 13 and the inner coil 12 are in contact with each other and form a lattice structure as shown in FIG. 6 to be electrically connected to each other. Also, the core wire 14 is also electrically connected with the outer coil 13, and so although if the outer coil 13 or the inner coil 12 is cut as shown in FIG. 7, current can bypass a point A at which the coil is cut, and then continuously flow. As a result, although some portions of the coils 12 and 13 are cut, the lifespan of the filament 10 is not terminated, thus the lifespan of the filament 10 and the fluorescent lamp can be increased.

In the above, while the structural characteristic of the filament 10 according to the present invention is illustrated, the conditions under which evaporation or scattering of the emitter 11 applied to the filament 10 is reduced to increase the lifespan of the fluorescent lamp will be described below.

The present inventor has found that the lifespan of the filament 10 depends sensitively on a temperature when the fluorescent lamp is turned ON. On the basis of the above, a method of designing the filament 10 for maintaining the temperature of the filament 10 within an appropriate range temperature will be described below.

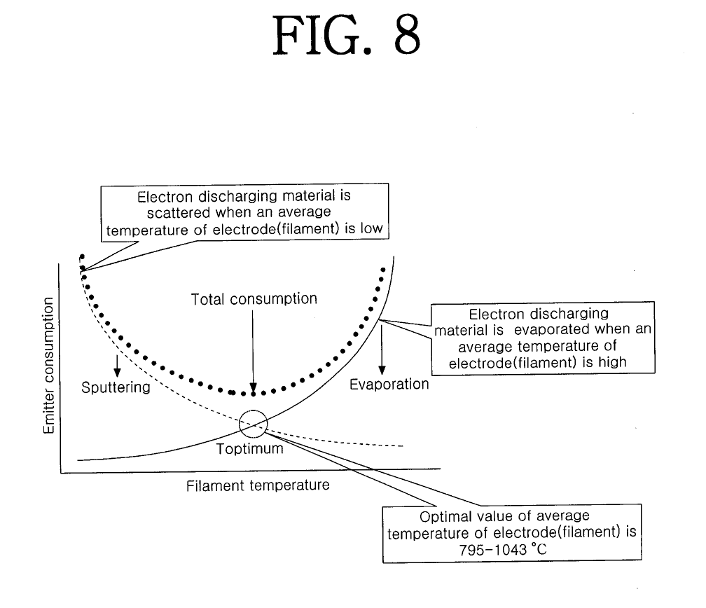

FIG. 8 is a graph showing a consumption amount of the emitter 11 according to the temperature of the filament 10. As shown in FIG. 8, if the temperature of the filament 10 is extremely low, a hot spot is generated at a portion of the filament 10 and a sputtering is generated on the hot spot to generate a scattering phenomenon in which the emitter 11 applied to the filament 10 is scattered and blown away. Due to the scattering, the lifespan of the filament 10 is reduced. On the contrary, if the temperature of the filament 10 is extremely high, the emitter 11 is evaporated, this evaporation of the emitter causes a reduction of the lifespan of the filament 10. Therefore, in order to prevent the lifespan of the fluorescent lamp from being decreased due to abrupt consumption of the emitter 11, it is necessary to maintain the temperature of the filament 10 within an appropriate range Tₒₚₜᵢₘᵤₘ.

According to the inventor's experiments, the experiment was performed under the condition in which the filament 10 having a structure shown in FIG. 4 was installed in a fluorescent lamp including a glass tube having a diameter of 15.8 to 16.2 mm. In the experiment, a hot spot was generated on the filament 10 when the temperature of the filament 10 was lower than 795° C., and when the temperature of the filament 10 was higher than 1043° C., energy loss of the filament 10 was increased so that a luminous efficiency (Lm/watt) was decreased and an evaporation amount of the emitter 11 applied to the filament 10 was abruptly increased abruptly. As a result of the experiment, it is preferable to maintain the temperature of the filament 10 within a range from 795 to 1,043° C.

In this invention, the temperature of the filament 10 is simplified and indicated by means of the Rh/Rc as a parameter. Table 1 represents an average temperature of the filament 10 according to Rh/Rc. Here, Rc means a cold resistance which is a resistance of the filament 10 at a normal temperature before the fluorescent lamp is turned on, and Rh means a heat resistance which is a resistance of the filament 10 in a stable state in which the fluorescent lamp is turned on and heated.

TABLE 1
Average Temperature of Filament according to Rh/Rc

| Rh/Rc | Temperature of Filament (° C.) |
|---|---|
| 4.6 | 759 |
| 4.8 | 795 |
| 5.0 | 832 |
| 5.2 | 867 |
| 5.4 | 903 |
| 5.6 | 938 |
| 5.8 | 973 |
| 6.0 | 1008 |
| 6.2 | 1043 |
| 6.4 | 1077 |

As shown in Table 1, as a ratio Rh/Rc of the cold resistance Rc and the heat resistance Rh was increased, the temperature of the filament 10 is increased. As described above, in order to maintain the temperature of the filament within a range of 795 to 1,043° C., Rh/Rc must have a value of 4.80 to 6.20. At this time, it is preferable that the diameter of the glass tube in which the filament is disposed is 15.8 to 16.2 mm, i.e., 16±0.2 mm and Rh has a value of 3.80 to 5.00Ω. If Rh is maintained at a value of 3.80 to 5.00Ω, Rc has a value of 0.78 to 1.20Ω.

Table 2 represents a survival rate in an on/off lifespan test of the fluorescent lamp according to Rh/Rc. Table 2 represent a survival rate of the fluorescent lamp in a case where the fluorescent lamp is turned on/off up to 600,000 times while Rh/Rc is varied.

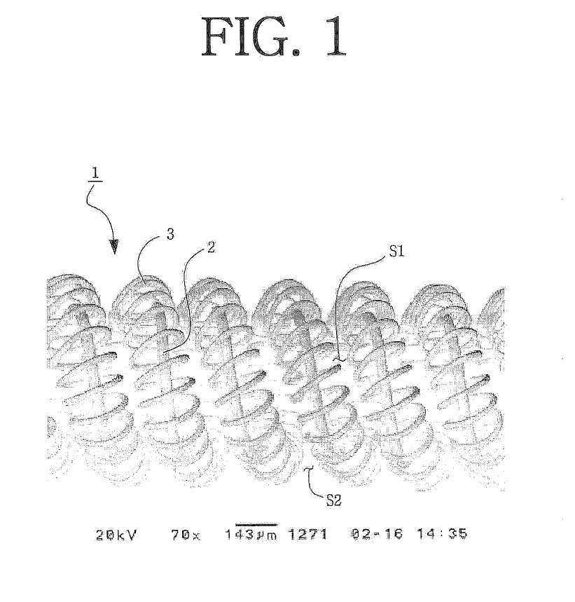

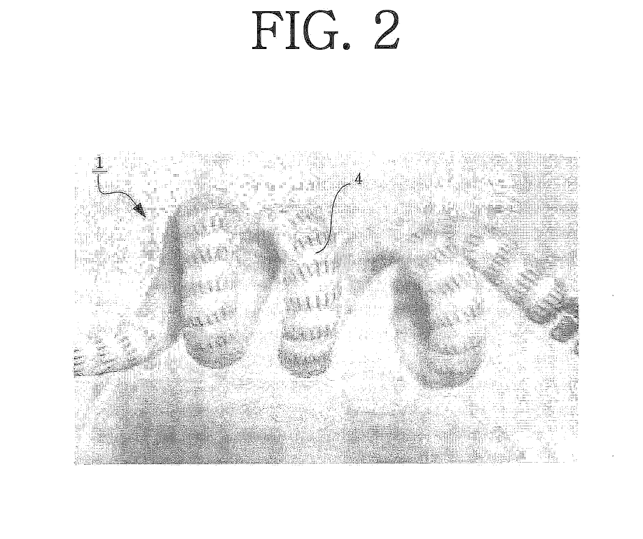

Here, while turning on/off the fluorescent lamp, a turning-on time and a turning-off time of the fluorescent lamp were maintained for 10 seconds each. In Table 2, the conventional structure means the conventional filament having the structure shown in FIGS. 1 and 2, and the triple structure means the filament having the structure shown in FIGS. 4 and 5, which will be the same below.

As shown in Table 2, while the survival rate of the fluorescent lamp employing the filament having the conventional structure was 0% when the turning on/off was performed 100,000 times, the survival rate of the fluorescent lamp employing the filament having the triple structure 0 was 100%. In particular, the survival rate of the fluorescent lamp employing the filament of the present invention was 70% or more when Rh/Rc was maintained at 4.8 to 6.2 and turning on/off was performed 400,000 times, and the survival rate was 50% or more even when turning on/off was performed 600,000 times. That is, it will be appreciated that the lifespan of the fluorescent lamp was remarkably increased.

TABLE 2
Survival Rate of Fluorescent Lamp according to Turning on/off Times

| Utilized | | Temperature | Turning on/off Times (Unit; 10,000 times) | | | | | | | |
|---|---|---|---|---|---|---|---|---|---|---|
| Filament | Rh/Rc | of Filament (° C.) | 0 | 1.5 | 10 | 20 | 30 | 40 | 50 | 60 |
| Conventional | 3.0 | 456 | 100 | 99 | 0 | 0 | 0 | 0 | 0 | 0 |
| Structure | | | | | | | | | | |
| Triple | 3.0 | 456 | 100 | 100 | 67 | 0 | 0 | 0 | 0 | 0 |
| Structure 1 | | | | | | | | | | |
| Triple | 4.0 | 648 | 100 | 100 | 100 | 32 | 0 | 0 | 0 | 0 |
| Structure 2 | | | | | | | | | | |
| Triple | 4.5 | 741 | 100 | 100 | 100 | 78 | 52 | 0 | 0 | 0 |
| Structure 3 | | | | | | | | | | |
| Triple | 4.8 | 795 | 100 | 100 | 100 | 100 | 92 | 73 | 61 | 53 |
| Structure 4 | | | | | | | | | | |
| Triple | 5.0 | 832 | 100 | 100 | 100 | 100 | 100 | 97 | 86 | 76 |
| Structure 5 | | | | | | | | | | |
| Triple | 5.5 | 921 | 100 | 100 | 100 | 100 | 100 | 97 | 89 | 78 |
| Structure 6 | | | | | | | | | | |
| Triple | 6.0 | 1008 | 100 | 100 | 100 | 100 | 87 | 95 | 82 | 71 |
| Structure 7 | | | | | | | | | | |
| Triple | 6.2 | 1043 | 100 | 100 | 100 | 100 | 76 | 71 | 59 | 50 |
| Structure 8 | | | | | | | | | | |
| Triple | 6.5 | 1095 | 100 | 100 | 87 | 31 | 0 | 0 | 0 | 0 |
| Structure 9 | | | | | | | | | | |
| Triple | 7.0 | 1180 | 100 | 100 | 65 | 0 | 0 | 0 | 0 | 0 |
| Structure 10 | | | | | | | | | | |

Table 3 represents the weight of the remained emitter 11 according to turning on/off times. Prior to turning on/off the fluorescent lamp, the weight of the emitter applied to the filament having a conventional structure was 3.5 mg, and the weight of the emitter applied to the filament having the triple structure was 12 mg.

TABLE 3
Weight (mg) of Remained Emitter according to Turning on/off Times

| Applied | | Temperature | Turning on/off Times (Unit; 10,000 times) | | | | | | | |
|---|---|---|---|---|---|---|---|---|---|---|
| Filament | Rh/Rc | of Filament (° C.) | 0 | 1.5 | 10 | 20 | 30 | 40 | 50 | 60 |
| Conventional | 3.0 | 456 | 3.5 | 0.5 | 0.0 | 0.0 | 0.0 | 0.0 | 0.0 | 0.0 |
| Structure | | | | | | | | | | |
| Triple | 3.0 | 456 | 12.0 | 9.0 | 0.7 | 0.0 | 0.0 | 0.0 | 0.0 | 0.0 |
| Structure 1 | | | | | | | | | | |
| Triple | 4.0 | 648 | 12.0 | 9.3 | 6.6 | 3.9 | 0.0 | 0.0 | 0.0 | 0.0 |
| Structure 2 | | | | | | | | | | |
| Triple | 4.5 | 741 | 12.0 | 11.3 | 7.7 | 4.9 | 2.3 | 0.0 | 0.0 | 0.0 |
| Structure 3 | | | | | | | | | | |
| Triple | 4.8 | 795 | 12.0 | 11.5 | 9.3 | 7.6 | 5.9 | 4.1 | 2.3 | 0.6 |
| Structure 4 | | | | | | | | | | |
| Triple | 5.0 | 832 | 12.0 | 11.6 | 9.7 | 8.0 | 6.3 | 4.6 | 2.9 | 1.2 |
| Structure 5 | | | | | | | | | | |
| Triple | 5.5 | 921 | 12.0 | 11.7 | 10.0 | 8.3 | 6.6 | 4.9 | 3.2 | 1.5 |
| Structure 6 | | | | | | | | | | |
| Triple | 6.0 | 1,008 | 12.0 | 11.5 | 9.8 | 8.1 | 6.4 | 4.7 | 3.0 | 1.3 |
| Structure 7 | | | | | | | | | | |
| Triple | 6.2 | 1,043 | 12.0 | 11.7 | 9.2 | 7.5 | 5.7 | 3.9 | 2.1 | 0.3 |
| Structure 8 | | | | | | | | | | |
| Triple | 6.5 | 1,095 | 12.0 | 11.5 | 7.8 | 3.1 | 0.0 | 0.0 | 0.0 | 0.0 |
| Structure 9 | | | | | | | | | | |
| Triple | 7.0 | 1,180 | 12.0 | 11.3 | 4.2 | 0.0 | 0.0 | 0.0 | 0.0 | 0.0 |
| Structure 10 | | | | | | | | | | |

It will be appreciated that while the emitter applied to the filament having a conventional structure was completely consumed and the lifespan of the filament is terminated when the fluorescent lamp was turned on/off more than 15,000 times, the emitter 11 was remained on all the filaments 10 having the triple structure to which an amount of the emitter 11 three times or more that of the emitter applied to the conventional structure was applied after the fluorescent lamp was turned on/off 100,000 times.

In particular, it will be appreciated that when Rh/Rc was 4.8 to 6.2, about 50% of the emitter 11 is remained even after the fluorescent lamp was turned on/off 300,000 times, and the emitter 11 was not completely exhausted even after the fluorescent lamp was turned on/off 600,000 times. This is because, when Rh/Rc is lower than 4.8, the temperature of the filament 10 is not sufficiently high to generate a hot spot at the filament 10 so that the emitter 11 applied to the filament 10 is scattered, and when Rh/Rc is higher than 6.2, the temperature of the filament 10 is excessively increased and the emitter 11 is evaporated. Therefore, in order to increase the lifespan of the fluorescent lamp, it is preferable to maintain the Rh/Rc within a range of 4.8 to 6.2.

### INDUSTRIAL APPLICABILITY

Unlike the conventional filament in which an emitter can not be applied to a space between a core region and a coil, according to the filament for the fluorescent lamp of the present invention, an emitter can be applied to a space between a core region and a coil of the filament, and so the amount of the emitter is increased about three times. In addition, since an outer coil and an inner coil constituting the filament form a lattice structure and are electrically connected with each other, the fluorescent lamp can be turned on even when a portion of the coil is cut. As a result, the lifespan of the fluorescent lamp can be increased.

Further, a cold resistance Rc and a heat resistance Rh of the filament are optimized to maintain the temperature of the filament with a range of 795 to 1043° C., whereby scattering or evaporation of the emitter generated on the filament is suppressed to increase the amount of the remained emitter, whereby the lifespan of the fluorescent lamp can be increased.

While the invention has been shown and described with reference to certain exemplary embodiments thereof, it will be understood by those skilled in the art that various changes in form and details may be made therein without departing from the spirit and scope of the invention as defined by the appended claims.

1. A filament for a fluorescent lamp comprising an inner coil wound in a spiral shape in one direction, a core wire wound in a spiral shape to surround the inner coil in a longitudinal direction of the inner coil, and an outer coil wound in a spiral shape to surround the core wire and surround the inner coil together with the core wire, characterized in that a ratio (Rh/Rc) between a heat resistance (Rh) and a cold resistance (Rc) of the filament is about 4.8 to about 6.2.

2. The filament according to claim 1, wherein the cold resistance (Rc) is 0.78 to 1.20Ω.

3. The filament according to claim 1, wherein the heat resistance (Rh) is 3.80 to 5.00Ω.

4. The filament according to claim 1, wherein the outer coil is wound to form a space between the unit outer coil surrounding the inner coil and the adjacent unit outer coil surrounding the inner coil, and the inner coil, the outer coil and the core wire are electrically connected to each other.

5. A fluorescent lamp comprising the filament according to claim 1 and having a diameter of 16±0.2 mm.

6. A fluorescent lamp comprising the filament according to claim 2 and having a diameter of 16±0.2 mm.

7. A fluorescent lamp comprising the filament according to claim 3 and having a diameter of 16±0.2 mm.

8. A fluorescent lamp comprising the filament according to claim 4 and having a diameter of 16±0.2 mm.
